(19) United States
(12) Patent Application Publication
(10) Pub. No.: US 2026/0067436 A1
(43) Pub. Date: Mar. 5, 2026

(54) IMAGE PROJECTION METHOD, NON-TRANSITORY COMPUTER-READABLE STORAGE MEDIUM STORING PROGRAM, AND INFORMATION PROCESSING DEVICE

(71) Applicant: SEIKO EPSON CORPORATION, Tokyo (JP)

(72) Inventor: Shuji OKANO, OITA-SHI (JP)

(21) Appl. No.: 19/313,445

(22) Filed: Aug. 28, 2025

(30) Foreign Application Priority Data
Aug. 29, 2024 (JP) 2024-147333

(51) Int. Cl. H04N 9/31

(52) U.S. Cl. CPC H04N 9/3185; H04N 9/3147; H04N 9/3194

(57) ABSTRACT

An image projection method includes acquiring in advance first shape information indicating shapes of a first image at a plurality of positions of a projection surface in a case in which the first image is projected on each of the positions from a first projector, when a second projector is projecting a second image on a position overlapping at least a part of the first image on the projection surface, acquiring first information for moving the position of the first image on the projection surface, outputting second information for moving the position of the second image on the projection surface by a movement amount corresponding to the first information, and generating, based on the first shape information and the first information, first correction information for applying geometric correction corresponding to a position after the movement of the first image to the first image.

The present application is based on, and claims priority from JP Application Serial Number 2024-147333, filed Aug. 29, 2024, the disclosure of which is hereby incorporated by reference herein in its entirety.

### BACKGROUND

### 1. Technical Field

The present disclosure relates to an image projection method, a non-transitory computer-readable storage medium storing a program, and an information processing device.

### 2. Related Art

JP-A-2019-95633 discloses a multi-projection optical system including a master projector and one or more slave projectors. In the multi-projection optical system described in JP-A-2019-95633, the master projector transmits an optical shift amount to the slave projectors when optical shift is performed and the slave projectors perform edge blend correction based on the received optical shift amount.

JP-A-2019-95633 is an example of the related art.

In the multi-projection optical system described in JP-A-2019-95633, when the position of an image on a projection surface changes because of the optical shift, the shape of the image sometimes changes from a shape before movement. In this case, in the related art, it is necessary to manually adjust the shape of the image again, and it is desired to reduce the time and effort of a user.

### SUMMARY

According to an aspect of the present disclosure, there is provided an image projection method including: acquiring in advance first shape information indicating shapes of a first image at a plurality of positions of a projection surface in a case in which the first image is projected on each of the positions from a first projector; when a second projector is projecting a second image on a position overlapping at least a part of the first image on the projection surface, acquiring first information for moving a position of the first image on the projection surface; outputting second information for moving a position of the second image on the projection surface by a movement amount corresponding to the first information; and generating, based on the first shape information and the first information, first correction information for applying geometric correction corresponding to a position after the movement of the first image to the first image.

According to an aspect of the present disclosure, there is provided a non-transitory computer-readable storage medium storing a program, the program causing at least one processor to execute: acquiring in advance first shape information indicating shapes of a first image at a plurality of positions of a projection surface in a case in which the first image is projected on each of the positions from a first projector; when a second projector is projecting a second image on a position overlapping at least a part of the first image on the projection surface, acquiring first information for moving the position of the first image on the projection surface; outputting second information for moving a position of the second image on the projection surface by a movement amount corresponding to the first information; and generating, based on the first shape information and the first information, first correction information for applying geometric correction corresponding to a position after the movement of the first image to the first image.

According to an aspect of the present disclosure, there is provided an information processing device including at least one processor configured to execute: acquiring in advance first shape information indicating shapes of a first image at a plurality of positions of a projection surface in a case in which the first image is projected on each of the positions from the first projector; when a second projector is projecting a second image on a position overlapping at least a part of the first image on the projection surface, acquiring first information for moving the position of the first image on the projection surface; outputting second information for moving a position of the second image on the projection surface by a movement amount corresponding to the first information; and generating, based on the first shape information and the first information, first correction information for applying geometric correction corresponding to a position after the movement of the first image to the first image.

### BRIEF DESCRIPTION OF THE DRAWINGS

FIG. 1 is a diagram schematically illustrating a system used in an image projection method according to an embodiment.

FIG. 2 is a block diagram of a first projector.

FIG. 3 is a diagram illustrating an entire image.

FIG. 4 is a diagram illustrating a relationship between the entire image and projectable regions of projectors.

FIG. 5 is a diagram illustrating an entire image after lens shift of the related art.

FIG. 6 is a diagram illustrating an entire image after lens shift in the image projection method according to the embodiment.

FIG. 7 is a flowchart of the image projection method according to the embodiment.

FIG. 8 is a diagram illustrating acquisition of first shape information.

FIG. 9 is a diagram illustrating acquisition of third correction information.

### DESCRIPTION OF EMBODIMENTS

A preferred embodiment according to the present disclosure is explained below with reference to the accompanying drawings. Note that, in the drawings, dimensions and scales of units are different from actual ones as appropriate, and some portions are schematically illustrated in order to facilitate understanding. The scope of the present disclosure is not limited to the embodiment unless, in the following explanation, there is explanation to the effect that the present disclosure is limited.

### 1. Embodiment

### 1-1. Overview of a System Used for an Image Projection Method

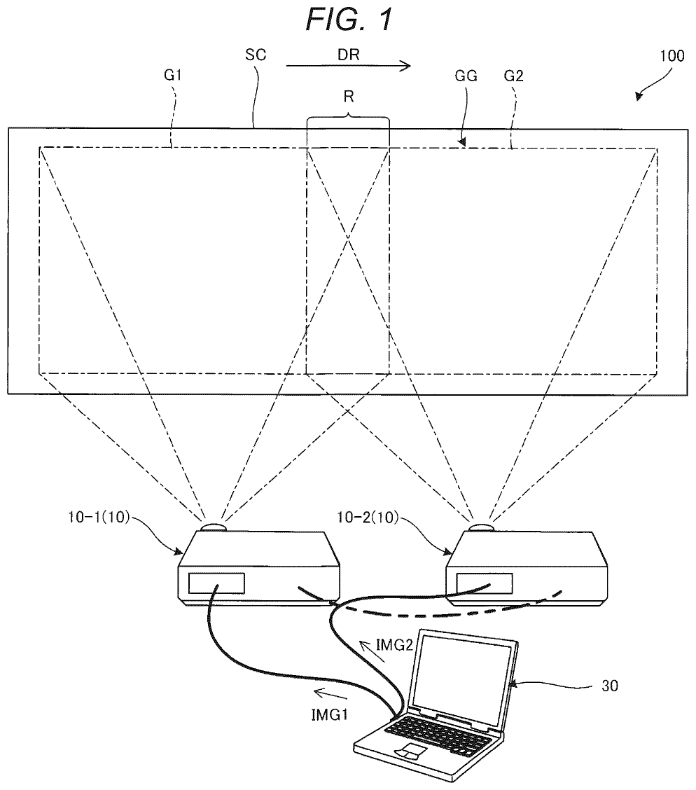

FIG. 1 is a diagram illustrating an overview of a system 100 used for an image projection method according to an embodiment. The system 100 is a multi-projection optical system that projects an entire image GG onto a projection surface SC.

The system 100 includes, as illustrated in FIG. 1, a first projector 10-1, a second projector 10-2, and a terminal device 30. The first projector 10-1 is an example of a “projector”. In the following explanation, the first projector 10-1 and the second projector 10-2 are sometimes referred to as projectors 10 without being distinguished from each other.

The system 100 projects the entire image GG onto the projection surface SC using a plurality of projectors 10. In an example illustrated in FIG. 1, the system 100 projects the entire image GG onto the projection surface SC using two projectors 10. The projection surface SC is the surface of an object such as a screen. In the example illustrated in FIG. 1, the projection surface SC is a plane.

The projection surface SC is not limited to the plane and may be, for example, a curved surface. In the present embodiment, an aspect in which the number of projectors 10 provided in the system 100 is two is exemplified. However, without being limited to this aspect, the number may be three or more. That is, the entire image GG may include images projected from three or more projectors 10.

The first projector 10-1 is a display device that projects, onto the projection surface SC, a first image G1 indicated by video data IMG1 output from the terminal device 30. The second projector 10-2 is a display device that projects, onto the projection surface SC, a second image G2 indicated by video data IMG2 output from the terminal device 30.

The first image G1 is projected onto the projection surface SC from the first projector 10-1 and the second image G2 is projected onto the projection surface SC from the second projector 10-2 as explained above, whereby the entire image GG including the first image G1 and the second image G2 is projected onto the projection surface SC. The first image G1 and the second image G2 are arranged in this order in an arrangement direction DR. Here, the first image G1 and the second image G2 are projected onto the projection surface SC in a state of being joined to each other such that the entire image GG displays one image. In the example illustrated in FIG. 1, the first image G1 is projected onto a region on the left side in FIG. 1 of the projection surface SC and the second image G2 is projected onto a region on the right side in FIG. 1 of the projection surface SC. The end portion on the right side in FIG. 1 of the first image G1 and the end portion on the left side in FIG. 1 of the second image G2 are joined to each other. That is, the end portion on the right side in FIG. 1 of the first image G1 overlaps the end portion on the left side in FIG. 1 of the second image G2.

Parts of the first image G1 and the second image G2 overlap each other in a superimposition region R. The superimposition region R is a region where blending processing explained below for making a joint between the first image G1 and the second image G2 less conspicuous is applied. As explained above, in the system 100, the superimposition region R for the parts of the first image G1 projected from the first projector 10-1 and the second image G2 projected from the second projector 10-2 to overlap each other on the projection surface SC is set.

The first projector 10-1 has a lens shift function of changing the position of the first image G1 on the projection surface SC while keeping the position and the orientation of the first projector 10-1 with respect to the projection surface SC fixed. Similarly, the second projector 10-2 has the lens shift function of changing the position of the second image G2 on the projection surface SC while keeping the position and the orientation of the second projector 10-2 with respect to the projection surface SC fixed. The lens shift function is also referred to as optical shift function.

The first projector 10-1 has a correction function of correcting the shape of the first image G1 on the projection surface SC. Similarly, the second projector 10-2 has the correction function of correcting the shape of the second image G2 on the projection surface SC.

In the present embodiment, the first projector 10-1 is a main machine and controls an operation of the second projector 10-2, which is a sub-machine. The first projector 10-1 maintains the shape of the first image G1 on the projection surface SC with the correction function of the first projector 10-1 even if the position of the first image G1 on the projection surface SC changes by the lens shift function of the first projector 10-1. Further, by controlling the operation of the second projector 10-2, the first projector 10-1 changes the position of the second image G2 on the projection surface SC with the lens shift function of the second projector 10-2 and maintains the shape of the second image G2 on the projection surface SC with the correction function of the second projector 10-2. Accordingly, it is possible to change the position of the entire image GG on the projection surface SC while maintaining the shape of the entire image GG.

The second projector 10-2 is configured the same as the first projector 10-1 except that the operation of the second projector 10-2 is controlled by the first projector 10-1. Note that the second projector 10-2 only has to have a configuration in which the operation of the second projector 10-2 can be controlled by the first projector 10-1 and may have a configuration different from the configuration of the first projector 10-1. When the number of projectors 10 provided in the system 100 is three or more, among the three or more projectors 10, one projector 10 is a main machine and each of the other two or more projectors 10 is a sub-machine.

The terminal device 30 is a device having a function of dividing video data indicating a single image into a plurality of pieces of video data to be projected by the plurality of projectors 10 and a function of supplying the divided pieces of video data to the projectors 10 corresponding to the pieces of video data.

The terminal device 30 in the present embodiment divides video data indicating one image into the video data IMG1 and the video data IMG2 and thereafter supplies the video data IMG1 to the first projector 10-1 and supplies the video data IMG2 to the second projector 10-2. The terminal device 30 may supply the video data IMG1 and the video data IMG2 to the first projector 10-1. In this case, the first projector 10-1 supplies the video data IMG2 to the second projector 10-2. The terminal device 30 may supply the video data to the first projector 10-1 and the first projector 10-1 may divide the video data.

In the example illustrated in FIG. 1, the terminal device 30 is a laptop computer. The terminal device 30 is not limited to the laptop computer and may be, for example, a desktop computer, a smartphone, or a tablet terminal or may be a video player, a digital versatile disk (DVD) player, a Blu-ray disc player, a hard disk recorder, a television tuner, a set-top box for a cable television (CATV), or a video game machine.

### 1-2. Projector

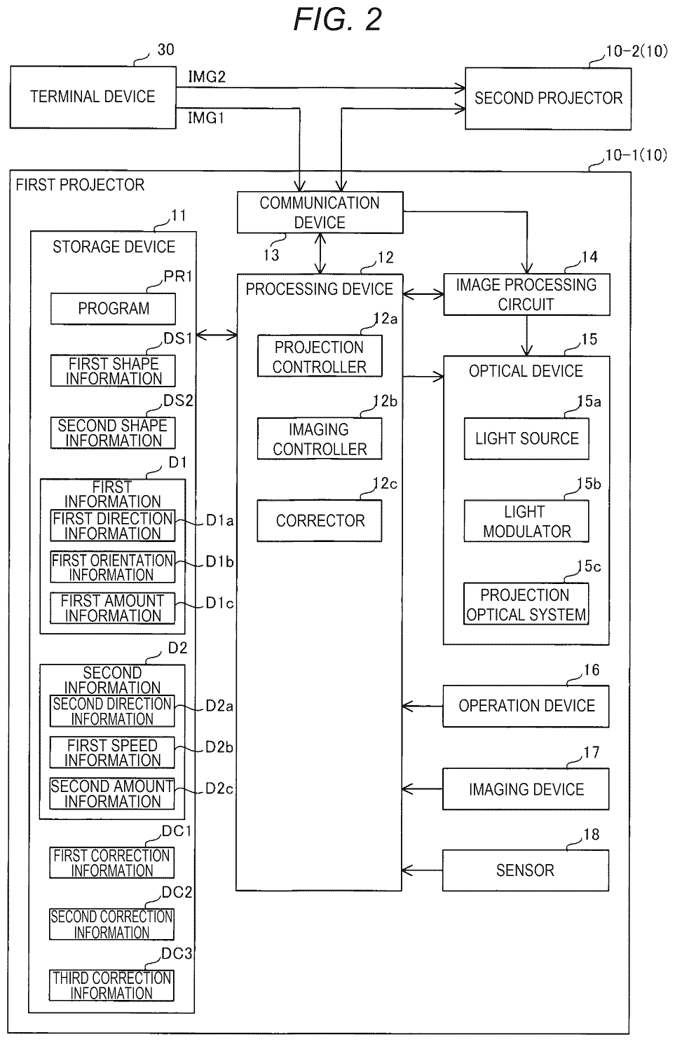

FIG. 2 is a block diagram of the first projector 10-1. In FIG. 2, besides the first projector 10-1, a connection state of the second projector 10-2 and the terminal device 30 to the first projector 10-1 is illustrated. In FIG. 2, the configuration of the first projector 10-1 is representatively illustrated. However, the configuration of the second projector 10-2 is the same as the configuration of the first projector 10-1 except that the second projector 10-2 does not execute a program PR1 explained below. Therefore, in the following explanation of elements of the second projector 10-2, the first projector 10-1 only has to be read as the second projector 10-2 and the video data IMG1 only has to be read as the video data IMG2. In the following explanation, concerning the elements of the projectors 10, the elements of the first projector 10-1 and the elements of the second projector 10-2 are sometimes distinguished by adding a suffix “−1” to reference signs of the elements of the first projector 10-1 and adding a suffix “−2” to reference signs of the elements of the second projector 10-2.

As illustrated in FIG. 2, the first projector 10-1 includes a storage device 11, a processing device 12, a communication device 13, an image processing circuit 14, an optical device 15, an operation device 16, an imaging device 17, and a sensor 18. These devices are communicatively coupled to each other.

The storage device 11 is a storage device that stores programs to be executed by the processing device 12 and data to be processed by the processing device 12. The storage device 11 includes, for example, a hard disk drive or a semiconductor memory. A part or the entire storage device 11 may be provided in a storage device on the outside of the first projector 10-1, a server, or the like.

The storage device 11 stores a program PR1, first shape information DS1, second shape information DS2, first information D1, second information D2, first correction information DC1, second correction information DC2, and third correction information DC3.

The program PR1 is a program for executing an image projection method explained in detail below.

The first shape information DS1 is information indicating the shapes of the first image G1 at a plurality of positions of the projection surface SC in the case in which the first image G1 is projected from the first projector 10-1 to each of the positions. Specifically, for example, when a target shape of the first image G1 is a quadrangle, the first shape information DS1 is information concerning coordinate values indicating, for each position of the first image G1 on the projection surface SC, a plurality of positions including the positions of four corners and the positions of four sides of the first image G1 on the projection surface SC. The coordinate values are, for example, coordinate values of a display coordinate system set in the optical device 15 explained below or a coordinate system associated with the display coordinate system. However, as explained below, the shape of the first image G1 on the projection surface SC is different for each position because of the influence of the lens shift and may be a shape deformed from the target shape.

As explained above, the first shape information DS1 indicates a correspondence relationship between a position in the case in which the first image G1 is projected on each of a plurality of positions of the projection surface SC from the first projector 10-1 and the shape of the first image G1 on the projection surface SC. The first shape information DS1 only has to be information directly or indirectly indicating deformation states of the first image G1 at the positions on the projection surface SC and is not limited to the information indicating the coordinate values explained above and may be, for example, imaging data obtained by imaging the first image G1 on the projection surface SC with the imaging device 17, may be information indicating a value such as a variable indicating a degree of deformation of the shape of the first image G1, or may be information indicating a correction value for correcting the first image G1 into a desired shape.

The second shape information DS2 is information indicating the shapes of the second image G2 at a plurality of positions of the projection surface SC in the case in which the second image G2 is projected from the second projector 10-2 to each of the positions. Specifically, for example, when a target shape of the second image G2 is a quadrangle, the second shape information DS2 is information concerning coordinate values indicating, for each position of the second image G2 on the projection surface SC, a plurality of positions including the positions of four corners and the positions of four sides of the second image G2 on the projection surface SC. The coordinate values are, for example, coordinate values of a display coordinate system set in the optical device 15 explained below or a coordinate system associated with the display coordinate system. However, as explained below, the shape of the second image G2 on the projection surface SC is different for each position because of the influence of the lens shift and is sometimes a shape deformed from the target shape.

As explained above, the second shape information DS2 indicates a correspondence relationship between the plurality of positions of the projection surface SC onto which the second image G2 is projected from the second projector 10-2 and the shape of the second image G2 on the projection surface SC. The second shape information DS2 only has to be information directly or indirectly indicating deformation states of the second image G2 at the positions on the projection surface SC and is not limited to the information indicating the coordinate values explained above and may be, for example, imaging data obtained by imaging the second image G2 on the projection surface SC with the imaging device 17, may be information indicating a value such as a variable indicating a degree of deformation of the shape of the second image G2, or may be information indicating a correction value for correcting the second image G2 into a desired shape.

The first information D1 is information for moving the position of the first image G1 on the projection surface SC when the second projector 10-2 projects the second image G2 on a position overlapping at least a part of the first image G1 on the projection surface SC. Specifically, the first information D1 is one of information for optically moving the position of the first image G1 and information for electronically moving the position of the first image G1 and indicates, for example, a movement amount and a movement direction of the first image G1 on the projection surface SC. Hereinafter, optically moving the position of a projection image is sometimes referred to as “lens shift” and electrically moving the position of the projection image is sometimes referred to as “electronic shift”. In the following explanation, an aspect of using the lens shift is mainly explained. However, the same applies to the electronic shift. The description “lens shift” can be read as “electronic shift” as appropriate.

The first information D1 includes first direction information D1a, first orientation information D1b, and first amount information D1c.

The first direction information D1a is information indicating upward, downward, left, and right that are based on a main body of the first projector 10-1 and, in the case of the optical shift, indicates a direction in which a lens of a projection optical system 15c of the first projector 10-1 is moved and, in the case of the electronic shift, indicates a direction in which an image is moved on a light modulator 15b of the first projector 10-1. Here, upward based on the main body of the first projector 10-1 is upward determined in the specifications of the first projector 10-1.

The first orientation information D1b is information indicating an installation orientation of the first projector 10-1. The first orientation information D1b is, for example, information indicating a detection result of the sensor 18 of the first projector 10-1.

The first amount information D1c is information indicating a movement amount of the position of the first image G1 on the projection surface SC. More specifically, the first amount information D1c is, in the case of the optical shift, information indicating the number of steps of the motor provided in a mechanism that moves, for the lens shift, the lens of the projection optical system 15c of the first projector 10-1 and is, in the case of the electronic shift, information indicating the number of movement pixels of an image on the light modulator 15b of the first projector 10-1.

The first orientation information D1b only has to be information indicating a relationship of an up-down direction based on the main body of the first projector 10-1 with respect to upward and downward that are based on the direction of gravity and is, for example, information indicating whether the first projector 10-1 is a so-called ceiling hanging. Here, the relationship indicated by the first orientation information D1b may include information indicating an inclination angle with respect to the horizontal plane or may include information indicating the direction of the first projector 10-1 with respect to the projection surface SC in addition to the direction of the first projector 10-1 with respect to upward and downward that are based on gravity information. For example, the first orientation information D1b may include information indicating whether projection is so-called front projection for projecting from a viewer side or rear projection for projecting from the rear surface of the projection surface SC. When the front projection and the rear projection are considered, the first orientation information D1b may include information indicating four installation orientations including front ceiling hanging projection and rear ceiling hanging projection besides the front projection and the rear projection. A method of acquiring a orientation indicated by the first orientation information D1c may be, for example, a method of reading installation information of the first projector 10-1 and acquiring the orientation based on the setting information besides a method of acquiring the orientation based on a detection result of the sensor 18. In this case, the sensor 18 may be omitted.

The second information D2 is information for moving the position of the second image G2 on the projection surface SC by a movement amount corresponding to the first information D1. Specifically, the second information D2 is information for controlling the operation of the second projector 10-2 and is one of information for optically moving the position of the second image G2 and information for electronically moving the position of the second image G2 and indicates, for example, a movement amount and a movement direction of the second image G2 on the projection surface SC. Typically, the movement amount and the movement direction indicated by the second information D2 are equal to the movement amount and the movement direction indicated by the first information D1. In the present embodiment, the second information D2 includes information indicating moving speed of the second image G2 on the projection surface SC according to necessity besides the information indicating the movement amount and the movement direction of the second image G2 on the projection surface SC.

The second information D2 includes second direction information D2a, first speed information D2b, and second amount information D2c.

The second direction information D2a is information indicating upward, downward, left, and right that are based on a main body of the second projector 10-2 and indicates, in the case of the optical shift, a direction in which a lens of the projection optical system 15c of the second projector 10-2 is moved and indicates, in the case of the electronic shift, a direction in which an image is moved on the light modulator 15b of the second projector 10-2. Here, upward based on the main body of the second projector 10-2 is upward determined in the specifications of the second projector 10-2.

The first speed information D2b is information for controlling the driving speed of the motor, and indicates a speed equal to the speed at which the first projector 10-1 moves the position of the first image G1. The first speed information D2b may be included in the second information D2 when the moving speed of the first image G1 is lower than maximum moving speed of the second image G2 and may not be included in the second information D2 when the moving speed of the first image G1 is higher than the maximum moving speed of the second image G2.

The second amount information D2c is information indicating a movement amount of the position of the second image G2 on the projection surface SC. More specifically, the second amount information D2c is, in the case of the optical shift, information indicating the number of steps of a motor provided in a mechanism that moves, for the lens shift, the lens of the projection optical system 15c of the second projector 10-2 and is, in the case of the electronic shift, information indicating the number of movement pixels of an image on the light modulator 15b of the second projector 10-2.

The first correction information DC1 is information for performing, on the first image G1, geometric correction corresponding to a position after movement of the first image G1. Specifically, the first correction information DC1 is, for example, information indicating a correction value in order to perform, on the first image G1, the geometric correction corresponding to the position after the movement of the first image G1.

The second correction information DC2 is information for performing, on the second image G2, geometric correction corresponding to a position after movement of the second image G2. Specifically, the second correction information DC2 is, for example, information indicating a correction value in order to perform, on the second image G2, the geometric correction corresponding to the position after the movement of the second image G2.

The third correction information DC3 is information concerning correction of the superimposition region R of the first image G1 and the second image G2 on the projection surface SC at the time when the position of the entire image GG is changed. Specifically, the third correction information DC3 is, for example, information indicating values of width, a shape, a blend curve, and the like after correction of a blend region R1 explained below at the time when the position of the entire image GG is changed.

The processing device 12 is a processing device having a function of controlling the units of the first projector 10-1 and a function of processing various data. The processing device 12 includes at least one processor such as a central processing unit (CPU). The processing device 12 may be configured by a single processor or may be configured by a plurality of processors. Some or all of the functions of the processing device 12 may be implemented by hardware such as a digital signal processor (DSP), an application specific integrated circuit (ASIC), a programmable logic device (PLD), or a field programmable gate array (FPGA). The processing device 12 may be integrated with the image processing circuit 14.

The communication device 13 is a communication device capable of communicating with various types of equipment and acquires the video data IMG1 from the terminal device 30 and communicates with the second projector 10-2. For example, the communication device 13 is a wired communication device of a wired local area network (LAN), a universal serial bus (USB), or a high definition multimedia interface (HDMI) or a wireless communication device of, a low power wide area (LPWA), a wireless LAN including Wi-Fi, or Bluetooth. Each of “HDMI”, “Wi-Fi”, and “Bluetooth” is a registered trademark.

The image processing circuit 14 is a circuit that performs necessary processing on the video data IMG1 received from the communication device 13 and inputs the video data IMG1 to the optical device 15. The image processing circuit 14 includes, for example, a not-illustrated frame memory, loads the video data IMG1 in the frame memory, executes various kinds of processing such as resolution conversion processing, resize processing, and distortion correction processing as appropriate, and inputs the video data IMG1 to the optical device 15. The image processing circuit 14 may execute, according to necessity, processing such as OSD (On Screen Display) processing of generating image information for menu display, operation guide, or the like and combining the image information into the video data IMG1. The image processing circuit 14 may correct the shape of the first image G1 based on the first correction information DC1 stored in the storage device 11 or may correct a portion of the first image G1 used for the superimposition region R based on the third correction information DC3 stored in the storage device 11.

The optical device 15 is a device that projects image light onto the projection surface SC. The optical device 15 includes a light source 15a, the light modulator 15b, and the projection optical system 15c.

The light source 15a includes a light source such as a halogen lamp, a xenon lamp, an ultrahigh-pressure mercury lamp, a light emitting diode (LED), or a laser light source and outputs red light, green light, and blue light. The light modulator 15b draws an image based on the video data IMG1 supplied from the terminal device 30. The light modulator 15b includes three light modulation elements provided to correspond to red, green, and blue. The light modulation elements include, for example, transmissive liquid crystal panels, reflective liquid crystal panels, or a digital mirror devices (DMDs) and modulate lights of colors corresponding thereto to generate an image lights of the colors. The image lights of the colors generated by the light modulator 15b are combined by a color combination optical system to be full color image light. The projection optical system 15c is an optical system including a projection lens that forms an image of the full color image light emitted from the light modulator 15b and projects the image onto the projection surface SC. The image drawn by the light modulator 15b, that is, a drawn image is projected onto the projection surface SC via the projection lens.

The optical device 15 includes a mechanism that changes a relative positional relationship between the light modulator 15b and the projection optical system 15c. An optical lens shift function is implemented by changing the positional relationship. That is, the optical device 15 changes the relative positional relationship between the light modulator 15b and the projection optical system 15c to thereby change the position of the first image G1 on the projection surface SC while keeping the position and the orientation of the first projector 10-1 with respect to the projection surface SC fixed. Typically, the lens shift function is implemented by a mechanism including a stepping motor that moves the position of the projection lens that emits image light to the projection surface SC.

In the optical device 15, a drawing position in the light modulator 15b can be changed. An electronic shift function may be implemented by changing the drawing position. That is, the optical device 15 may change the drawing position in the light modulator 15b to thereby change the position of the first image G1 on the projection surface SC while keeping the position and the orientation of the first projector 10-1 with respect to the projection surface SC fixed.

The operation device 16 is a device that receives operation of a user. For example, the operation device 16 includes an operation panel and a remote controller light receiver, both of which are not illustrated in the figures. The operation panel is provided in an exterior housing of the first projector 10-1 and outputs a signal based on operation of the user. The remote controller light receiver receives an infrared signal from a not-illustrated remote controller, decodes the infrared signal, and outputs a signal based on operation on the remote controller. Note that the operation device 16 is provided according to necessity and a part of the operation device 16 may be omitted.

The imaging device 17 is a digital camera including an imaging element such as a charge coupled device (CCD) or a Complementary Metal Oxide Semiconductor (CMOS). The imaging element includes a plurality of pixels.

The sensor 18 is a sensor for estimating the orientation of the projector 10 with respect to the projection surface SC. The sensor 18 includes, for example, a distance sensor and an acceleration sensor. The distance sensor is a time-of-flight (ToF) distance sensor and measures the shape of the projection surface SC. The acceleration sensor is a sensor that detects acceleration in three axes orthogonal to one another and detects acceleration acting on the projector 10. An installation orientation of the first projector 10-1 can be estimated based on a detection result of the sensor 18.

The sensor 18 only has to be able to obtain a detection result necessary for estimating a orientation of the projector 10 with respect to the projection surface SC. For example, one of the distance sensor and the acceleration sensor may be omitted in the sensor 18 or the sensor 18 may include an inertial sensor such as an angular velocity sensor and a camera instead of one or both of the distance sensor and the acceleration sensor. The orientation of the projector 10 with respect to the projection surface SC may be estimated based on input information such as menu setting of the first projector 10-1.

In the first projector 10-1 explained above, the processing device 12 executes the program PR1 stored in the storage device 11 to thereby function as a projection controller 12a, an imaging controller 12b, and a corrector 12c. Therefore, the processing device 12 includes the projection controller 12a, the imaging controller 12b, and the corrector 12c.

The projection controller 12a controls operations of the image processing circuit 14 and the optical device 15 of each of the first projector 10-1 and the second projector 10-2. More specifically, the projection controller 12a causes the first projector 10-1 to project the first image G1 onto the projection surface SC and causes the second projector 10-2 to project the second image G2 onto the projection surface SC to thereby cause the first projector 10-1 and the second projector 10-2 to project the entire image GG onto the projection surface SC.

After the installation of the first projector 10-1 and the second projector 10-2 is completed, in order to acquire the first shape information DS1 and the second shape information DS2 in advance, the projection controller 12a causes the first projector 10-1 to project the first image G1 to each of a plurality of positions on the projection surface SC using the lens shift function of the first projector 10-1 and causes the second projector 10-2 to project the second image G2 to each of a plurality of positions on the projection surface SC using the lens shift function of the second projector 10-2.

After the acquisition of the first shape information DS1 and the second shape information DS2, the projection controller 12a corrects the shape of the first image G1 on the projection surface SC using the correction function of the first projector 10-1 based on the first correction information DC1 or corrects the shape of the second image G2 on the projection surface SC using the correction function of the second projector 10-2 based on the second correction information DC2.

The imaging controller 12b controls an operation of the imaging device 17 of one or both of the first projector 10-1 and the second projector 10-2. More specifically, the imaging controller 12b causes the imaging device 17 to capture the first image G1 projected on each of the plurality of positions on the projection surface SC or causes the imaging device 17 to capture the second image G2 projected on each of the plurality of positions on the projection surface SC.

The corrector 12c acquires the first shape information DS1 in advance based on a result of capturing the first image G1 projected on each of the plurality of positions on the projection surface SC with the imaging device 17 or acquires the second shape information DS2 in advance based on a result of capturing the second image G2 projected on each of the plurality of positions on the projection surface SC with the imaging device 17.

The corrector 12c acquires the third correction information DC3 in advance based on a result of capturing the first image G1 projected on each of the plurality of positions on the projection surface SC with the imaging device 17.

Further, the corrector 12c acquires, via the communication device 13, the first information D1 from a device for remotely operating the first projector 10-1 or a device such as the terminal device 30 and outputs the second information D2 based on the acquired first information D1.

The corrector 12c generates the first correction information DC1 based on the third correction information DC3, the first shape information DS1, and the first information D1 and generates the second correction information DC2 based on the second shape information DS2 and the second information D2. When the positions and the orientations of the first projector 10-1 and the second projector 10-2 with respect to the projection surface SC are changed, the first correction information DC1 and the second correction information DC2 are regenerated under new conditions according to necessity.

### 1-3. Entire Image

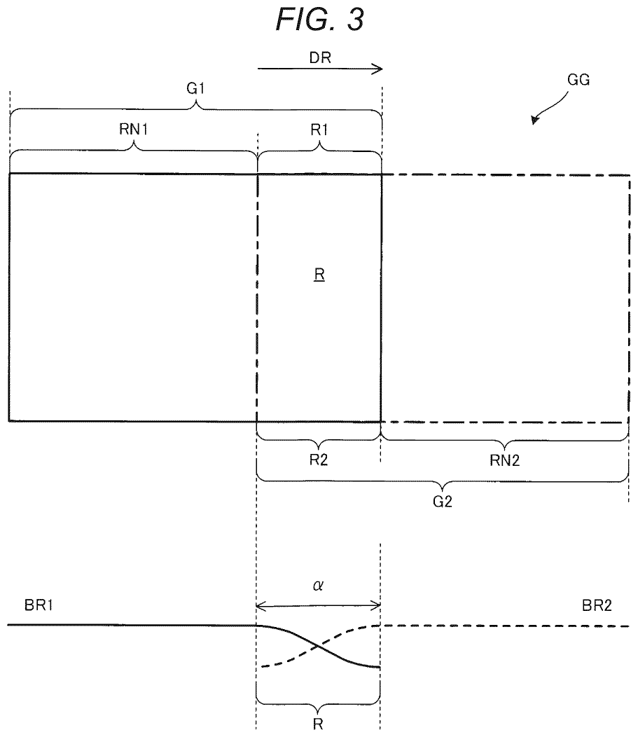

FIG. 3 is a diagram illustrating the entire image GG. FIG. 3 illustrates an example of a relationship between brightness BR1 of the first image G1 and brightness BR2 of the second image G2 in the case in which the brightness of the entire image GG is uniform.

The first image G1 at the time when the entire image GG is projected onto the projection surface SC includes a non-superimposition region RN1 and a blend region R1. The non-superimposition region RN1 is a region not overlapping the second image G2. The blend region R1 is a region overlapping the second image G2. The blend region R1 is subjected to blend processing. The blend processing changes brightness in the arrangement direction DR in which the first image G1 and the second image G2 are arranged such that the brightness of the superimposition region R at the time when the first image G1 and the second image G2 are projected to overlap each other in the superimposition region R coincides with the brightness of the non-superimposition region RN1.

The second image G2 at the time when the entire image GG is projected on the projection surface SC includes a non-superimposition region RN2 and a blend region R2. The non-superimposition region RN2 is a region not overlapping the first image G1. The blend region R2 is a region overlapping the first image G1. The blend region R2 is subjected to the blend processing.

In the blend region R1 of the first image G1, the brightness BR1 of the first image G1 changes from the brightness of the non-superimposition region RN1 to zero over a range α of the superimposition region R in the arrangement direction DR. In the blend region R1, the distribution of the brightness BR1 in the arrangement direction DR, that is, a blend curve only has to be set such that the brightness of the superimposition region R coincides with the brightness of the non-superimposition region RN1 and is not limited to the example illustrated in FIG. 3.

In the blend region R2 of the second image G2, the brightness BR2 of the second image G2 changes from the brightness of the non-superimposition region RN2 to zero over the range α of the superimposition region R in the direction opposite to the arrangement direction DR. In the second blend region R2, the distribution of the brightness BR2 in the arrangement direction DR, that is, a blend curve only has to be set such that the brightness of the superimposition region R coincides with the brightness of the non-superimposition region RN2 and is not limited to the example illustrated in FIG. 3.

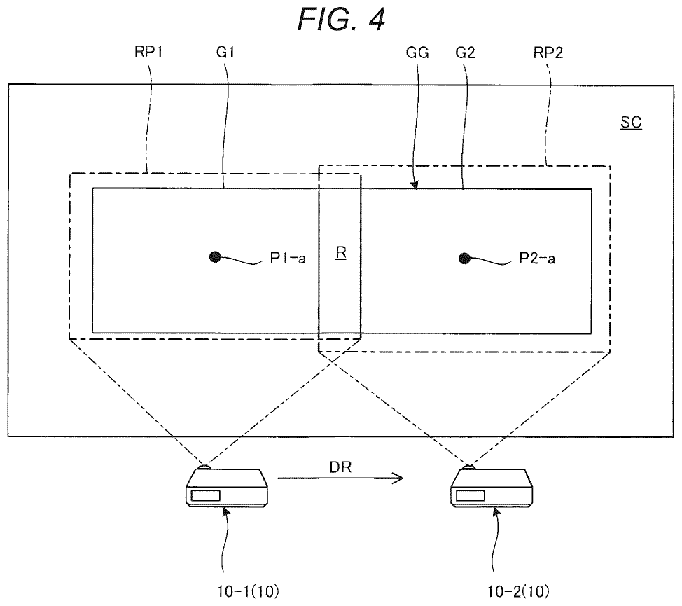

FIG. 4 is a diagram illustrating a relationship between the entire image GG and projectable regions RP1 and RP2 of the projectors 10. The projectable region RP1 is a maximum region in which projection can be performed by the first projector 10-1 and includes the first image G1. The projectable region RP2 is a maximum area in which projection can be performed by the second projector 10-2 and includes the second image G2.

FIG. 4 illustrates a state in which the entire image GG is displayed in a normal shape on the projection surface SC. In an example illustrated in FIG. 4, the shape of the entire image GG on the projection surface SC is a rectangle. Here, each of the shape of the first image G1 and the shape of the second image G2 is a rectangle on the projection surface SC. The position of the projectable region RP1 is a position P1-a and the position of the projectable region RP2 is a position P2-a.

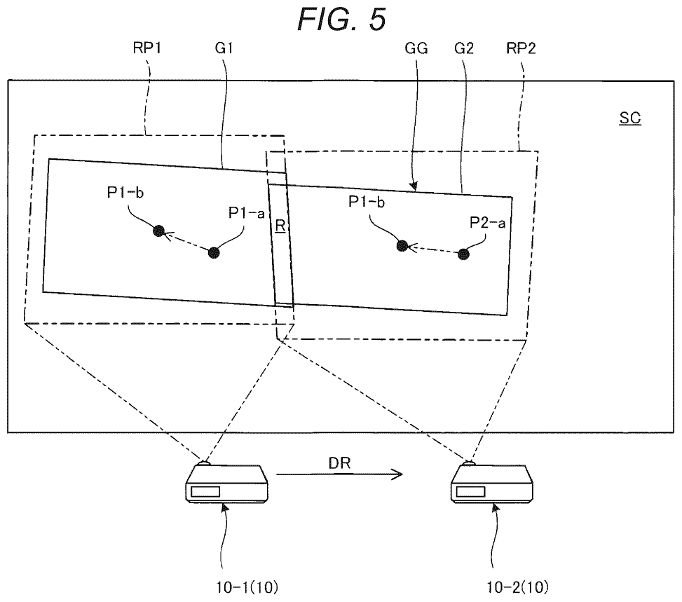

FIG. 5 is a diagram illustrating the entire image GG after the lens shift of the related art. FIG. 5 illustrates the entire image GG in the case in which the position of the projectable region RP1 is changed from the position P1-a to the position P1-b by the lens shift function of the first projector 10-1 and the position of the projectable region RP2 is changed from the position P2a to the position P2-b by the lens shift function of the second projector 10-2 without correcting the shapes of the first image G1 and the second image G2.

As illustrated in FIG. 5, the position of the first image G1 on the projection surface SC is changed according to the change of the position of the projectable region RP1. Similarly, the position of the second image G2 on the projection surface SC is changed according to the change of the position of the projectable region RP2.

Here, even when a movement direction and a movement amount from the position P1-a to the position P1-b are equal to a movement direction and a movement amount from the position P2-a to the position P2-b, the shapes of the first image G1 and the second image G2 on the projection surface SC are shapes different from normal shapes only by changing the positions of the projectable regions RP1 and RP2. As a result, the entire image GG on the projection surface SC also has a shape different from the normal shape. Such deformation of the shape of the entire image GG can occur even when the movement direction and the movement amount from the position P1-a to the position P1-b are equal to the movement direction and the movement amount from the position P2-a to the position P2-b.

Examples of a factor of the shape of the entire image GG on the projection surface SC being deformed according to the execution of the lens shift function as explained above include a difference in a type of the projection optical system 15c, a difference in a projection angle or a projection distance, and the like between the first projector 10-1 and the second projector 10-2.

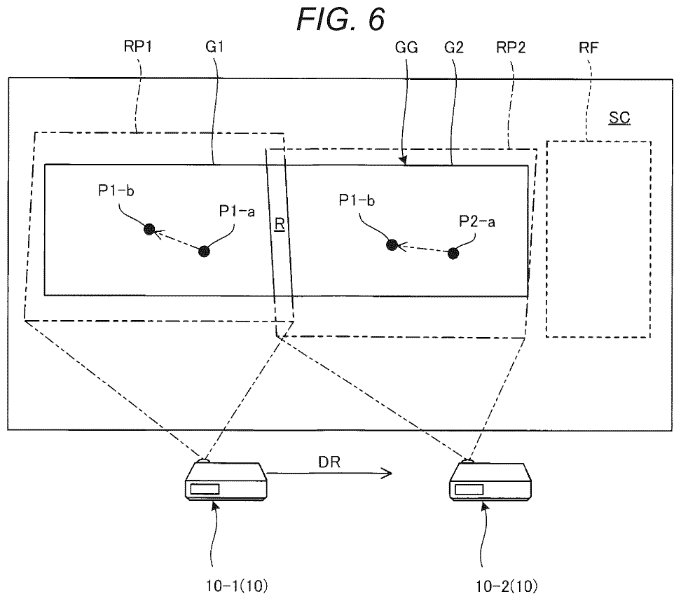

FIG. 6 is a diagram illustrating the entire image GG after the lens shift of the image projection method according to the embodiment. In the system 100, even when the position of the projectable region RP1 is changed from the position P1-a to the position P1-b and the position of the projectable region RP2 is changed from the position P2-a to the position P2-b, the shape of the entire image GG on the projection surface SC is maintained in the normal shape as illustrated in FIG. 6.

Here, the first projector 10-1 corrects the shape of the first image G1 into the normal shape in the projectable region RP1 with the correction function. Similarly, the second projector 10-2 corrects the shape of the second image G2 into the normal shape in the projectable region RP2 with the correction function. The correcting the shape into the normal shape means bringing the shape of an image close to a rectangle, typically, an oblong by correcting geometric distortion.

According to the change of the position of the entire image GG on the projection surface SC explained above, a free region RF can be generated in the projection surface SC. Accordingly, the free region RF can be used as a display or handwriting region for another content. When an object is placed in the front of a part of the screen SC, overlap of the entire image GG and the object can be eliminated by changing the position of the entire image GG. An object such as a screen including the projection surface SC may be moved if the shape, the position, and the like of a region of the projection surface SC onto which projection can be performed from the projector 10 do not change.

### 1-4. Image Projection Method

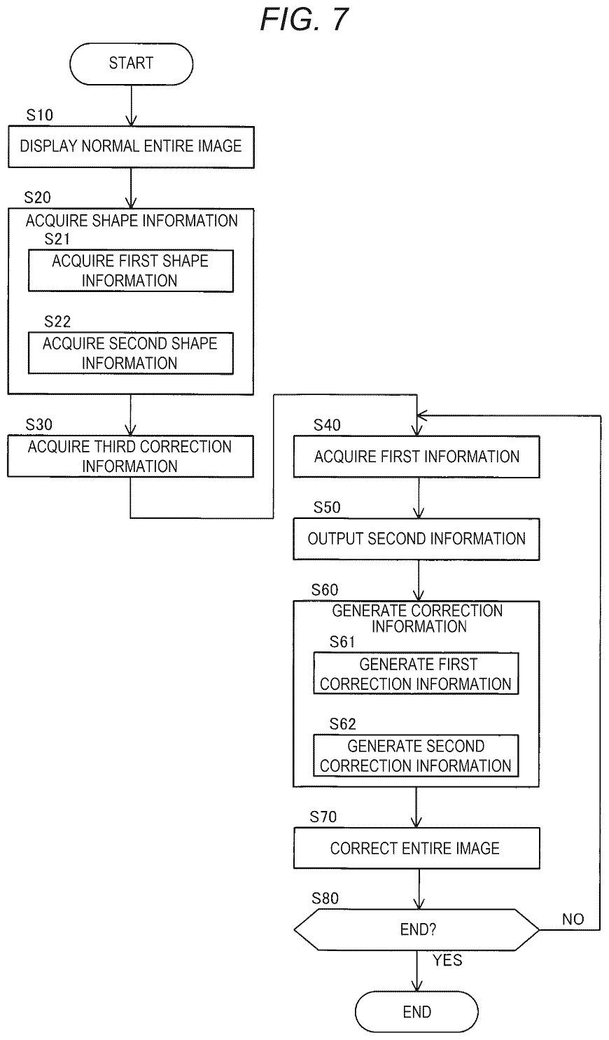

FIG. 7 is a flowchart of the image projection method according to the embodiment. The image projection method includes steps S10 to S70. These steps are performed by the processing device 12 of the first projector 10-1 executing the program PR1.

First, in step S10, the processing device 12 of the first projector 10-1 displays a normal entire image GG. Specifically, after fixing a relationship of the positions and the orientations of the first projector 10-1 and the second projector 10-2 with respect to the projection surface SC, in step S10, the processing device 12 functioning as the projection controller 12a of the first projector 10-1 causes the first projector 10-1 to project the first image G1 having the normal shape onto the projection surface SC and causes the second projector 10-2 to project the second image G2 having the normal shape onto the projection surface SC as illustrated in FIG. 4 referred to above. Accordingly, the entire image GG having the normal shape is projected onto the projection surface SC.

A method of projecting the entire image GG having the normal shape onto the projection surface SC in step S10 is not particularly limited. Publicly-known various geometric correction methods can be used. For example, based on a result of imaging the first image G1 and the second image G2 projected onto the projection surface SC with the imaging device 17, the shapes of the images are measured by a publicly-known image recognition technology and, based on a result of the measurement, the shapes of the first image G1 and the second image G2 are corrected by a publicly-known geometric correction method such that the entire image GG has a desired shape. In step S10, the width of the superimposition region R is determined and the blend processing is performed by a publicly-known technique such that the entire image GG has desired image quality.

After step S10, in step S20, the processing device 12 of the first projector 10-1 acquires the first shape information DS1 and the second shape information DS2 as shape information. Specifically, step S20 includes step S21 and step S22. In step S21, the processing device 12 functioning as the imaging controller 12b and the corrector 12c of the first projector 10-1 acquires the first shape information DS1 in advance. In step S22, the processing device 12 functioning as the imaging controller 12b and the corrector 12c of the first projector 10-1 acquires the second shape information DS2 in advance. The execution order of step S21 and step S22 is not particularly limited and is optional. “In advance” in steps S20 and S30 means a point in time before a function of moving the position of the entire image GG is executed.

After step S20, in step S30, the processing device 12 functioning as the corrector 12c of the first projector 10-1 acquires the third correction information DC3 in advance. In step S30, the processing device 12 generates third correction information DS3 using, as appropriate, a result of capturing an image using the imaging device 17 when generating the first shape information DS1 and the second shape information DS2 in step S20. Note that step S30 may be executed before step S20 or may be executed simultaneously with step S20.

After step S30, in step S40, the processing device 12 functioning as the corrector 12c of the first projector 10-1 acquires the first information D1. Here, the first information D1 is acquired by the processing device 12 of the first projector 10-1 based on, for example, information such as control information in the first projector 10-1 triggered by a control signal from a device for remotely operating the first projector 10-1 or a device such as the terminal device 30. Accordingly, an operation of the first projector 10-1 is controlled based on the first information D1.

After step S40, in step S50, the processing device 12 functioning as the corrector 12c of the first projector 10-1 outputs the second information D2. Here, the second information D2 is output from the first projector 10-1 to the second projector 10-2 as, for example, a control signal for controlling the operation of the second projector 10-2. Thus, the operation of the second projector 10-2 is controlled based on the second information D2.

As explained above, the second information D2 includes the second direction information D2a. The second direction information D2a is generated based on the first direction information D1a and the first orientation information D1b. Therefore, the outputting the second information D2 in step S50 includes outputting the second direction information D2a based on the first direction information D1a and the first orientation information D1b. Here, when the orientation of the first projector 10-1 and the orientation of the second projector 10-2 are different from each other, if the same direction is instructed, a direction in which an image is actually moved on the projection surface SC deviates. Thus, the second direction information D2a is generated from the orientation of the first projector 10-1 and the orientation of the second projector 10-2 such that the direction in which the image is actually moved on the projection surface SC is the same. For example, when the orientation of the first projector 10-1 is the orientation of the front ceiling hanging projection and is “upward” on the main body basis and “downward” on the gravity direction basis and the orientation of the second projector 10-2 is the orientation of the front projection and is “upward” on the main body basis and “upward” on the direction of gravity basis, if the movement direction of the image of the first projector 10-1 is the right direction, the movement direction of the image of the second projector 10-2 is the left direction.

When speed at which the first projector 10-1 moves the position of the first image G1 is referred to as first speed and maximum speed at which the second projector 10-2 can move the position of the second image G2 is referred to as second speed, the second information D2 includes the first speed information D2b, which is information indicating the first speed, when the first speed is lower than the second speed.

After step S50, in step S60, the processing device 12 functioning as the corrector 12c of the first projector 10-1 generates the first correction information DC1 and the second correction information DC2 as correction information. Step S60 includes step S61 and step S62. In step S61, the processing device 12 of the first projector 10-1 generates the first correction information DC1 based on the first shape information DS1 and the first information D1. In the present embodiment, in step S61, the processing device 12 of the first projector 10-1 generates the first correction information DC1 using the third correction information DC3 besides the first shape information DS1 and the first information D1. In step S62, the processing device 12 of the first projector 10-1 generates the second correction information DC2 based on the second shape information DS2 and the second information D2. The execution order of step S61 and step S62 is not particularly limited and is optional.

After step S60, in step S70, the processing device 12 functioning as the corrector 12c of the first projector 10-1 corrects the entire image GG based on the first correction information DC1 and the second correction information DC2. Specifically, in step S70, the processing device 12 of the first projector 10-1 controls the operations of the image processing circuit 14 and the optical device 15 of the first projector 10-1 based on the first correction information DC1 and controls the operations of the image processing circuit 14 and the optical device 15 of the second projector 10-2 based on the second correction information DC2. Accordingly, the shape of the first image G1 on the projection surface SC is corrected into the normal shape and the shape of the second image G2 on the projection surface SC is corrected into the normal shape. As a result, the shape of the entire image GG is corrected into the normal shape.

Here, correction timing of the first image G1 and correction timing of the second image G2 may be the same or may be different. The moving speed of the first image G1 and the moving speed of the second image G2 may be different from each other or may be equal to each other. However, when the correction timing of the first image G1 and the correction timing of the second image G2 are the same, the moving speed of the first image G1 and the moving speed of the second image G2 are preferably equal to each other. Accordingly, it is possible to display the entire image GG while reducing discomfort.

After step S70, in step S80, the processing device 12 determines whether to end the processing. This determination is made based on, for example, the presence or absence of an end instruction from the user. When not ending the processing (NO in step S80), the processing device 12 returns to step S40. Accordingly, steps S40 to S70 explained above are repeated. On the other hand, when ending the processing (YES in step S80), the processing device 12 ends the processing.

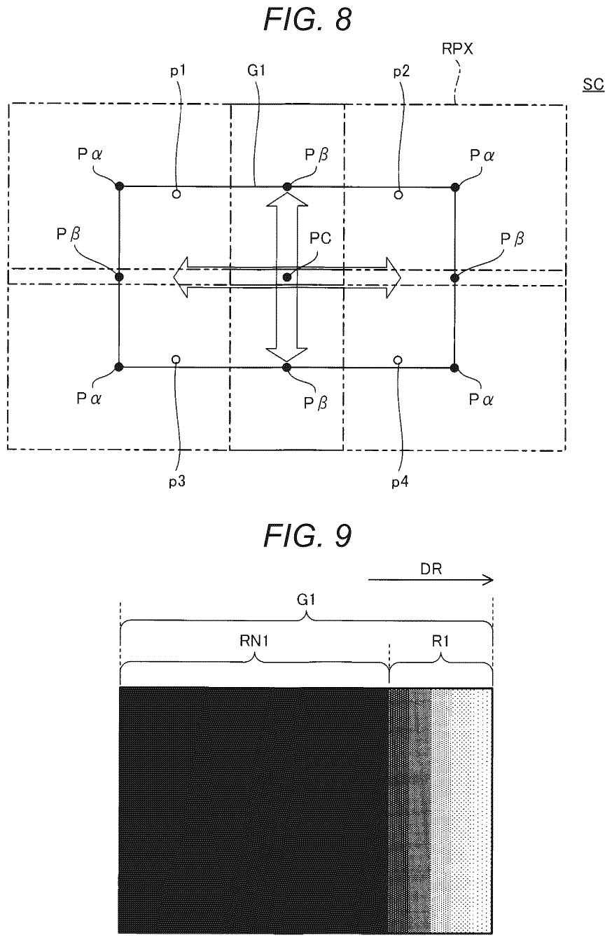

FIG. 8 is a diagram illustrating the acquisition of the first shape information DS1 in step S21. Hereinafter, the acquisition of the first shape information DS1 is representatively described. The acquisition of the second shape information DS2 in step S22 is performed the same as the acquisition of the first shape information DS1 in step S21 except that the projector 10 set as a target is different.

In step S21, as illustrated in FIG. 8, the processing device 12 of the first projector 10-1 moves the position of the first image G1 on the projection surface SC with the lens shift function. At this time, the processing device 12 of the first projector 10-1 captures the first image G1 at positions using the imaging device 17 and measures the shape of the first image G1 at the positions using a result of the imaging. At this time, the moving speed of the first image G1 on the projection surface SC is measured. Information indicating a result of the measurement may be stored in the storage device 11 and used to determine whether to include the first speed information D2b in the second information D2 in step S50.

The first image G1 in step S21 is not particularly limited and may be the same as or different from the first image G1 at the time of the projection of the entire image GG but is preferably an image illustrated in FIG. 9 explained below from the viewpoint of improving the detection accuracy of a shape in a captured image by the imaging device 17. A size relationship between the first image G1 and the projectable region RP1 in step S21 is not particularly limited but is preferably the same as a size relationship between the first image G1 and the projectable region RP1 at the time when the entire image GG is projected. From the viewpoint of improving the detection accuracy of the shape in the captured image by the imaging device 17, it is preferable that the second image G2 is not projected onto the projection surface SC in step S21 or the first image G1 and the second image G2 do not overlap on the projection surface SC.

In step S21, when the position of the first image G1 is the position of the center PC of the first image G1, a movement range of the position of the first image G1 on the projection surface SC is within a region surrounded by a quadrangle having four points p1, p2, p3, and p4 as corners. The point p1 is a point at a position on the projection surface SC and is a point at the uppermost and leftmost position that the center PC can reach with the lens shift function. The point p2 is a point at a position on the projection surface SC and is a point at the uppermost and rightmost position that the center PC can reach with the lens shift function. The point p3 is a point at a position on the projection surface SC and is a point at the lowermost and leftmost position that the center PC can reach with the lens shift function. The point p4 is a point at a position on the projection surface SC and is a point at the lowermost and rightmost position that the center PC can reach with the lens shift function.

In step S21, with the lens shift function, the center PC of the first image G1 sequentially moves in appropriate order to a plurality of positions in the region surrounded by the points p1, p2, p3, and p4. The plurality of positions are, for example, positions for each predetermined number of steps of the motor provided in the mechanism that moves the lens for the lens shift. The plurality of positions only has to be a plurality of positions dispersed within a necessary range of the region and may be dispersed in a partial region of the region or may be dispersed in the entire region. The plurality of positions may be arranged at equal intervals or at least some of the positions may not be arranged at equal intervals.

When the position of the first image G1 on the projection surface SC is changed by the lens shift function as explained above, the shape of the first image G1 on the projection surface SC changes. The first image G1 at the positions projected onto the projection surface SC is captured by the imaging device 17. Then, a contour of the first image G1 in the captured image is detected by a publicly-known image recognition technology. Information indicating coordinate values of four corners and midpoints of four sides of the detected contour is stored in the storage device 11 as the first shape information DS1 indicating the shape of the first image G1 on the projection surface SC. The information indicating the shape of the first image G1 in the first shape information DS1 may be information for each position of the first image G1 moving on the projection surface SC or for each imaging by the imaging device 17 but may include, according to necessity, information obtained by interpolating, with linear interpolation or the like, the shape of the first image G1 at a position where imaging is not performed.

As explained above, in step S21, the information indicating the relationship between the position and the shape of the first image G1 by the lens shift function is obtained as the first shape information DS1. In step S61, for example, after the position of the first image G1 on the projection surface SC is obtained based on the first information D1, the current shape of the first image G1 on the projection surface SC is obtained based on the obtained position and the relationship indicated by the first shape information DS1 and a correction value for geometrically correcting the shape of the first image G1 to offset the obtained shape is obtained. At that time, a correction value concerning the blend region R1 is also obtained using the third correction information DC3. Information indicating these correction values obtained as explained above is stored in the storage device 11 as the first correction information DC1.

Similarly, in step S22, the information indicating the relationship between the position and the shape of the second image G2 by the lens shift function is obtained as the second shape information DS2. In step S62, for example, after the position of the second image G2 on the projection surface SC is obtained based on the second information D2, the current shape of the second image G2 on the projection surface SC is obtained based on the obtained position and the relationship indicated by the second shape information DS2 and a correction value for geometrically correcting the shape of the second image G2 to offset the obtained shape is obtained. Information indicating the correction values obtained as explained above is stored in the storage device 11 as the second correction information DC2.

FIG. 9 is a diagram illustrating acquisition of the third correction information DC3. In the present embodiment, in step S30, the processing device 12 generates the third correction information DS3 using the imaging result of the imaging device 17 in step S20.

In the first image G1 used in step S21 explained above, as illustrated in FIG. 9, whereas the brightness of the non-superimposition region RN1 is uniform, the brightness of the blend region R1 increases or decreases further away from the non-superimposition region RN1.

In step S30, the contours of the non-superimposition region RN1 and the blend region R1 in the captured image are detected by a known image recognition technology using the captured image obtained by capturing the first image G1 with the imaging device 17 in step S21. In step S30, values of the width, the shape, the blend curve, and the like of the blend region R1 are obtained based on a result of detecting the non-superimposition region RN1 and the blend region R1 as explained above. Information indicating the obtained value is stored in the storage device 11 as the third correction information DC3.

In the image projection method explained above, since the second information D2 for moving the position of the second image G2 on the projection surface SC by a movement amount corresponding to the first information D1 is output in step S50, it is possible to maintain a positional relationship between the first image G1 and the second image G2 on the projection surface SC while reducing the time and effort of the user even if the position of the first image G1 on the projection surface SC moves. Further, since the first correction information DC1 for performing the geometric correction corresponding to the position after the movement of the first image G1 on the first image G1 is generated based on the first shape information DS1 and the first information D1 in the step S61, it is possible to maintain the shape of the first image G1 on the projection surface SC while reducing the time and effort of the user by using the first correction information DC1 even if the position of the first image G1 on the projection surface SC moves.

Further, since the second correction information DC2 is generated in step S62 as explained above, even if the position of the second image G2 on the projection surface SC moves, it is possible to maintain the shape of the second image G2 on the projection surface SC while reducing the time and effort of the user by using the second correction information DC2.

Further, as explained above, when the position of the entire image GG is changed, since the first correction information DC1 is generated using the third correction information DC3 in step S61, even if the entire image GG on the projection surface SC moves, the image quality of the superimposition region R on the projection surface SC can be maintained. When the position of the entire image GG is changed, the processing device 12 may generate the second correction information DC2 using the third correction information DC3 in step S62.

Since the second direction information D2a is output in step S50 as explained above, it is possible to maintain the positional relationship between the first image G1 and the second image G2 on the projection surface SC even when the installation orientation of the first projector 10-1 and the installation orientation of the second projector 10-2 are different.

Further, since the second information D2 includes the information indicating the first speed, which is the moving speed of the first image G1, as explained above, it is possible to move the position of the second image G2 on the projection surface SC at the first speed by referring to the second information D2. As a result, for example, when the first image G1 and the second image G2 are simultaneously moved, it is possible to move the positions of the first image G1 and the second image G2 on the projection surface SC at the same speed.

As explained above, since the first information D1 is the information for optically moving the position of the first image G1 or the information for electronically moving the position of the first image G1, it is possible to generate the second information D2 or generate the first correction information DC1 according to the information for optically or electronically moving the position of the first image G1.

### 3. Modifications

The embodiment exemplified above can be variously modified. Specific aspects of modifications applicable to the embodiment explained above are exemplified below. Two or more aspects optionally selected from the following exemplifications can be combined as appropriate to the extent that no contradiction occurs among the aspects.

### 3-1. Modification 1

In the embodiment explained above, the aspect in which the first projector 10-1 controls the operation of the second projector 10-2 is exemplified. However, this aspect is not limiting. For example, the lens shift function and the correction function of the projectors 10 may be executed by an external device such as the terminal device 30 or the server controlling the operation of each of the first projector 10-1 and the second projector 10-2.

### 3-2. Modification 2

In the embodiment explained above, the configuration in which the blend processing is performed is exemplified. However, this aspect is not limiting. The first blend region R1b and the second blend region R2b may be omitted. In this case, only the correction of the positions and the shapes of the first image G1 and the second image G2 is performed.

### 3-3. Modification 3

In the embodiment explained above, the aspect in which the first shape information DS1 and the second shape information DS2 are acquired using the imaging device 17 of the first projector 10-1 is exemplified. However, this aspect is not limiting. For example, the acquisition of the first shape information DS1 and the second shape information DS2 may be performed using the imaging device 17 of the second projector 10-2 instead of the imaging device 17 of the first projector 10-1 or in addition to the imaging device 17 of the first projector 10-1.

### 3-4. Modification 4

The program PR1 in the embodiment explained above may be provided in a state of being recorded on a computer-readable and non-transitory recording medium. The computer is, for example, the processing device 12 or the terminal device 30. The program PR1 in the embodiment explained above may be provided in a form of being downloaded from the server to the computer through a network.

### 4. Appendixes

A summary of the present disclosure is appended below.

(Appendix 1) According to a first aspect that is a preferred example of the present disclosure, there is provided an image projection method including: acquiring in advance first shape information indicating shapes of a first image at a plurality of positions of a projection surface in a case in which the first image is projected on each of the positions from a first projector; when a second projector is projecting a second image on a position overlapping at least a part of the first image on the projection surface, acquiring first information for moving a position of the first image on the projection surface; outputting second information for moving a position of the second image on the projection surface by a movement amount corresponding to the first information; and generating, based on the first shape information and the first information, first correction information for applying geometric correction corresponding to a position after the movement of the first image to the first image.

In the aspect explained above, since the second information for moving the position of the second image on the projection surface by the movement amount corresponding to the first information is output, it is possible to maintain the positional relationship between the first image and the second image on the projection surface while reducing the time and effort of the user even if the position of the first image on the projection surface moves. Since the first correction information for performing, on the first image, geometric correction corresponding to the position of the first image after the movement is generated based on the first shape information and the first information, it is possible to maintain the shape of the first image on the projection surface while reducing the time and effort of the user by using the first correction information even if the position of the first image on the projection surface moves.

(Appendix 2) In a second aspect that is a preferred example of the first aspect, the image projection method further includes: acquiring in advance second shape information indicating shapes of the second image at a plurality of positions on the projection surface in a case in which the second image is projected on each of the positions from the second projector; and generating, based on the second shape information and the second information, second correction information for applying geometric correction corresponding to a position after movement of the second image to the second image. In the aspect explained above, even if the position of the second image on the projection surface moves, it is possible to maintain the shape of the second image on the projection surface while reducing the time and effort of the user by using the second correction information.

(Appendix 3) In a third aspect that is a preferred example of the first aspect or the second aspect, the image projection method further includes acquiring in advance third correction information concerning correction of a superimposition region of the first image and the second image on the projection surface at a time when a position of an entire image including the first image and the second image is changed, and the first correction information is generated using the third correction information. In the aspect explained above, even if the entire image on the projection surface moves, it is possible to maintain the image quality of the superimposition region on the projection surface.

(Appendix 4) In a fourth aspect that is a preferred example of any one of the first to third aspects, the first information includes: first direction information indicating a movement direction of the first image that is based on an installation orientation of the first projector; and first orientation information indicating the installation orientation of the first projector, and the outputting of the second information includes outputting, based on the first direction information and the first orientation information, second direction information indicating a movement direction of the second image that is based on an installation orientation of the second projector. In the aspect explained above, even when the installation orientation of the first projector and the installation orientation of the second projector are different, it is possible to maintain a positional relationship between the first image and the second image on the projection surface.

(Appendix 5) In a fifth aspect that is a preferred example of any one of the first to fourth aspects, when first speed at which the first projector moves the position of the first image is lower than second speed that is maximum speed at which the second projector moves the position of the second image, the second information includes information indicating the first speed. In the aspect explained above, it is possible to move the position of the second image on the projection surface at the first speed by referring to the second information. As a result, for example, when the first image and the second image are simultaneously moved, it is possible to move the positions of the first image and the second image on the projection surface at the same speed.

(Appendix 6) In a sixth aspect that is a preferred example of any one of the first to fifth aspects, the first information is one of information for optically moving the position of the first image and information for electronically moving the position of the first image. In the aspect explained above, it is possible to generate the second information and generate the first correction information according to the information for optically or electronically moving the position of the first image.

(Appendix 7) According to a seventh aspect that is a preferred example of the present disclosure, there is provided a non-transitory computer-readable storage medium storing a program, the program causing at least one processor to execute: acquiring in advance first shape information indicating shapes of a first image at a plurality of positions of a projection surface in a case in which the first image is projected on each of the positions from a first projector; when a second projector is projecting a second image on a position overlapping at least a part of the first image on the projection surface, acquiring first information for moving the position of the first image on the projection surface; outputting second information for moving the position of the second image on the projection surface by a movement amount corresponding to the first information; and generating, based on the first shape information and the first information, first correction information for applying geometric correction corresponding to a position after the movement of the first image to the first image.

In the aspect explained above, since the second information for moving the position of the second image on the projection surface by the movement amount corresponding to the first information is output, it is possible to maintain the positional relationship between the first image and the second image on the projection surface while reducing the time and effort of the user even if the position of the first image on the projection surface moves. Since the first correction information for performing, on the first image, geometric correction corresponding to the position of the first image after the movement is generated based on the first shape information and the first information, it is possible to maintain the shape of the first image on the projection surface while reducing the time and effort of the user by using the first correction information even if the position of the first image on the projection surface moves.

(Appendix 8) According to an eighth aspect that is a preferred example of the present disclosure, there is provided an information processing device including at least one processor configured to execute: acquiring in advance first shape information indicating shapes of a first image at a plurality of positions of a projection surface in a case in which the first image is projected on each of the positions from a first projector; when a second projector is projecting a second image on a position overlapping at least a part of the first image on the projection surface, acquiring first information for moving the position of the first image on the projection surface; outputting second information for moving the position of the second image on the projection surface by a movement amount corresponding to the first information; and generating, based on the first shape information and the first information, first correction information for applying geometric correction corresponding to a position after the movement of the first image to the first image.

In the aspect explained above, since the second information for moving the position of the second image on the projection surface by the movement amount corresponding to the first information is output, it is possible to maintain the positional relationship between the first image and the second image on the projection surface while reducing the time and effort of the user even if the position of the first image on the projection surface moves. Since the first correction information for performing, on the first image, geometric correction corresponding to the position of the first image after the movement is generated based on the first shape information and the first information, it is possible to maintain the shape of the first image on the projection surface while reducing the time and effort of the user by using the first correction information even if the position of the first image on the projection surface moves.

What is claimed is:

1. An image projection method comprising:
acquiring in advance first shape information indicating a shape of a first image at a plurality of positions of a projection surface in a case in which the first image is projected on each of the positions from a first projector;
when a second projector is projecting a second image on a position overlapping at least a part of the first image on the projection surface, acquiring first information for moving a position of the first image on the projection surface;
outputting second information for moving a position of the second image on the projection surface by a movement amount corresponding to the first information; and
generating, based on the first shape information and the first information, first correction information for applying geometric correction corresponding to a position after the movement of the first image to the first image.

2. The image projection method according to claim 1, further comprising:
acquiring in advance second shape information indicating shapes of the second image at a plurality of positions on the projection surface in a case in which the second image is projected on each of the positions from the second projector; and
generating, based on the second shape information and the second information, second correction information for applying geometric correction corresponding to a position after movement of the second image to the second image.

3. The image projection method according to claim 1, further comprising acquiring in advance third correction information concerning correction of a superimposition region of the first image and the second image on the projection surface at a time when a position of an entire image including the first image and the second image is changed, wherein
the first correction information is generated using the third correction information.

4. The image projection method according to claim 1, wherein
the first information includes:
first direction information indicating a movement direction of the first image that is based on an installation orientation of the first projector; and
first orientation information indicating the installation orientation of the first projector, and
the outputting the second information includes outputting, based on the first direction information and the first orientation information, second direction information indicating a movement direction of the second image that is based on an installation orientation of the second projector.

5. The image projection method according to claim 1, wherein, when first speed at which the first projector moves the position of the first image is lower than second speed that is maximum speed at which the second projector moves the position of the second image, the second information includes information indicating the first speed.

6. The image projection method according to claim 1, wherein the first information is one of information for optically moving the position of the first image and information for electronically moving the position of the first image.

7. A non-transitory computer-readable storage medium storing a program, the program causing at least one processor to execute:
acquiring in advance first shape information indicating shapes of a first image at a plurality of positions of a projection surface in a case in which the first image is projected on each of the positions from a first projector;
when a second projector is projecting a second image on a position overlapping at least a part of the first image on the projection surface, acquiring first information for moving the position of the first image on the projection surface;
outputting second information for moving the position of the second image on the projection surface by a movement amount corresponding to the first information; and
generating, based on the first shape information and the first information, first correction information for applying geometric correction corresponding to a position after the movement of the first image to the first image.

8. An information processing device comprising at least one processor configured to execute:
acquiring in advance first shape information indicating shapes of a first image at a plurality of positions of a projection surface in a case in which the first image is projected on each of the positions from a first projector;
when a second projector is projecting a second image on a position overlapping at least a part of the first image on the projection surface, acquiring first information for moving the position of the first image on the projection surface;
outputting second information for moving the position of the second image on the projection surface by a movement amount corresponding to the first information; and
generating, based on the first shape information and the first information, first correction information for applying geometric correction corresponding to a position after the movement of the first image to the first image.
